(19) United States
(12) Patent Application Publication
(10) Pub. No.: US 2026/0347511 A1
(43) Pub. Date: Nov. 5, 2026

(54) HIGH PRESSURE POLYMERIZATION OF ETHYLENE

(71) Applicant: Basell Polyolefine GmbH, Wesseling (DE)

(72) Inventors: Gerd Mannebach, Frankfurt/M (DE); Andre-Armand Finette, Frankfurt/M (DE); Christof Justus, Frankfurt/M (DE); Juergen Mohrbutter, Frankfurt/M (DE)

(73) Assignee: Basell Polyolefine GmbH, Wesseling (DE)

(21) Appl. No.: 19/485,819

(22) PCT Filed: May 24, 2024
(86) PCT No.: PCT/EP2024/064318

§ 371 Date: Nov. 19, 2025

(30) Foreign Application Priority Data
May 26, 2023 (EP) 23175771.7

(51) Int. Cl. C08F 2/02; C08F 2/01; C08F 2/38; C08F 110/02

(52) U.S. Cl. CPC C08F 2/02; C08F 2/01; C08F 2/38; C08F 110/02; C08F 2400/04

(57) ABSTRACT

A process for preparing ethylene homopolymers or copolymers performed in a tubular reactor, having a volume to surface ratio of more than 0.016, and ethylene homopolymers or copolymers made therefrom. A process for the preparation of ethylene homopolymers or copolymers, in a facility comprising: (A) a high-pressure tubular reactor, used in a continuous flow mode, with (i) a reaction fluid comprising ethylene introduced into the reactor at a reactor inlet, and (ii) polymer leaving the reactor at a reactor outlet, and (B) a preheater, having an inlet and an outlet, comprising the steps of: a) compressing the reaction fluid to an elevated pressure; b) heating at least a portion of the reaction fluid in the preheater, thereby yielding heated reaction fluid; c) introducing the reaction fluid heated in step b) into the reactor at the reactor inlet; and d) polymerizing the reaction.

In general, the present disclosure relates to the field of chemistry. More specifically, the present disclosure relates to polymer chemistry. In particular, the present disclosure relates to a process for preparing ethylene homopolymers or copolymers as well as the polymers prepared therefrom.

### BACKGROUND OF THE DISCLOSURE

In some instances, polyethylene is prepared by different processes. In some instances, polymerization, in the presence of free-radical initiators at elevated pressures, is used to obtain polyethylene, including low density polyethylene (LDPE).

In some instances, a plant for preparing low density polyethylene includes a polymerization reactor and other equipment. In some instances, the reaction components are pressurized by a combination of two compressors, a primary compressor and a secondary compressor. In some instances and at the end of the polymerization sequence, a high-pressure polymerization unit further includes apparatuses like extruders and granulators for pelletizing the resulting polymer. In some instances, the polymerization unit provides for feeding monomers and comonomers, free-radical initiators, chain transfer agents or other substances at one or more positions to the polymerization reaction.

In some instances, the radically initiated polymerization of ethylenically unsaturated monomers under high pressure does not convert the monomers completely. In some instances, per pass of a tubular reactor or a reactor combination converts about 10% to 50% of the dosed monomers. In some instances, the reaction mixture leaves the reactor through a pressure control valve and is separated into polymeric and gaseous components with the unreacted monomers being recycled. In some instances, the pressure control valve is referred to as a let-down valve. In some instances and to avoid excessive decompression and compression steps, the separation into polymeric and gaseous components is carried out in two stages. In some instances, the monomer-polymer mixture, leaving the reactor, is transferred to a first separating vessel, wherein the separation in polymeric and gaseous components is carried out at a pressure and thereby allows recycling the ethylene and comonomers to the reaction mixture at a position between the primary compressor and the secondary compressor. In some instances, the first separating vessel is referred to as a high-pressure product separator. In some instances and at the first separation vessel's operating conditions, the polymeric components are in liquid state. In some instances, the liquid is transferred to a second separation vessel, wherein a further separation in polymeric and gaseous components takes place at lower pressure. In some instances, the second separation vessel is referred to as a low-pressure product separator. In some instances and from the second separation vessel, the ethylene and comonomers are separated from the mixture and fed to the primary compressor. The ethylene and comonomers are compressed to the pressure of the fresh ethylene feed and combined with fresh ethylene feed. The joined streams are further pressurized to the pressure of the high-pressure gas recycle stream.

In some instances, the low density polyethylene is used in applications based on blown films.

### SUMMARY OF THE DISCLOSURE

In a general embodiment, the present disclosure provides a process for the preparation of ethylene homopolymers or copolymers, in a facility including
(A) a high-pressure tubular reactor, used in a continuous flow mode with
   (i) a reaction fluid made from or containing ethylene introduced into the reactor at a reactor inlet and
   (ii) polymer leaving the reactor at a reactor outlet, and
(B) a preheater, having an inlet and an outlet,
including the steps of:
a) compressing the reaction fluid to an elevated pressure;
b) heating at least a portion of the reaction fluid in the preheater, thereby yielding heated reaction fluid;
c) introducing the reaction fluid heated in step b) into the reactor at the reactor inlet; and
d) polymerizing the reaction fluid at temperatures from 100 °C to 350 °C and pressures in the range from 180 MPa to 340 MPa, in the presence of free-radical polymerization initiators in the reactor,
wherein
   the tubular reactor has a volume V [in m³] and an inner surface area A [in m²],
   the ratio V/A is higher than 0.016, and
   the reactor is run at a monomer conversion in a range of from 22 to 31%.

In some embodiments, the reactor has a volume to inner surface area ratio in a range of from 0.016 to 0.025, alternatively from 0.019 to 0.022.

In some embodiments, the conversion rate is in a range of from 23 to 29, alternatively in a range of from 24 to 28, alternatively in a range of from 25 to 27.5, alternatively in a range of from 25.5 to 27, alternatively in a range of from 26 to 27.

In some embodiments, the tubular reactor has an inner diameter dᵢ of from 65 to 120 mm, alternatively from 70 mm to 110 mm.

In some embodiments, the tubular reactor has tubes of a length of from 5 m to 25 m.

In some embodiments, the design pressure p_{des} of the tubular reactor is from 240 MPa to 400 MPa.

In some embodiments, the feed rate of the reaction gas composition to the tubular reactor is from 80 t/h to 210 t/h.

In some embodiments, step b) includes adding one or more chain-transfer agents. In some embodiments, the chain transfer agent is selected from the group consisting of hydrogen, aliphatic and olefinic hydrocarbons, ketones, aldehydes and saturated aliphatic alcohols. In some embodiments, the chain-transfer agent is selected from the group consisting of saturated aliphatic aldehydes, 1-olefins and aliphatic hydrocarbons.

In some embodiments, the amount of added aldehydes and ketones is in a range of from 0.4 kg/t of prepared polymer to 10 kg/t of prepared polymer.

In some embodiments, propionic aldehyde is used as the chain transfer agent, in the absence of other chain transfer agents. In some embodiments, the chain transfer agent is a mixture of propionic aldehyde and one or more olefinic hydrocarbons.

In some embodiments, the average velocity of the reaction fluid at the outlet of the preheater is lower than the average velocity of the reaction fluid in the tubular reactor at the reactor inlet and the ratio of the average velocity of the reaction fluid in the tubular reactor at the reactor inlet to the average velocity of the reaction fluid in the preheater at the outlet of the preheater is in the range from 1.5 to 5.

In some embodiments, in step a), the pressure of the reaction fluid after compression ranges from 180 MPa to 320 MPa. In some embodiments, in step c), when introducing the heated reaction fluid into the reactor, the pressure of the reaction fluid ranges from 175 MPa to 315 MPa. In some embodiments, in step a), the pressure of the reaction fluid after compression ranges from 180 MPa to 320 MPa, and, in step c), when introducing the heated reaction fluid into the reactor, the pressure of the reaction fluid ranges from 175 MPa to 315 MPa.

In some embodiments, in step c), when introducing the heated reaction fluid into the reactor, the temperature of the reaction fluid ranges from 130 °C to 180 °C.

In some embodiments, the present disclosure provides a low density polyethylene having:
a) a density in a range of from 0.910 to 0.936 g/, determined according to ISO 1183-1 at 23 °C;
b) an Mw value in a range of from 70.000 to 100.000, where Mw is the weight average molecular weight, measured by GPC;
c) an Mn value in a range of from 18.000 to 24.000, where Mn is the number average molar mass, measured by GPC;
d) a gloss 20° value [as measured according to ASTM D 2457] of 74 or more;
e) a gloss 60° [as measured according to ASTM D 2457] of 114 or more;
f) a haze value [as measured according to ASTM D 1003] of less than 6;
g) a melt flow rate in a range of from 0.67 to 1.0 g/10, determined according to ISO 1133-1;
h) a dart drop impact strength, F50, in a range of from 130 to 200 g, determined according to ASTM D1709; or
i) a clarity in a range of from 97.0 to 99.3.

In some embodiments, the low density polyethylene has more than one of the characteristics (a)-(i).

In some embodiments, the low density polyethylene has the characteristics (a)-(i).

### BRIEF DESCRIPTION OF THE DRAWINGS

To assist those of ordinary skill in the relevant art in making and using the subject matter hereof, the appended drawings are provided as illustrative and not restrictive, wherein:

FIG. 1 is a schematic showing the flow pattern of a polymerization in an LDPE reactor.

FIG. 2 is a graph depicting molecular weight distribution depending on plant size.

### DETAILED DESCRIPTION OF THE DISCLOSURE

In some embodiments, the present disclosure provides a process for preparing an ethylene-based polymer by polymerizing ethylene and optionally one or more comonomers in a facility including (A) a high-pressure tubular reactor, used in a continuous flow mode with (i) a reaction fluid made from or containing ethylene introduced into the reactor at a reactor inlet and (ii) polymer leaving the reactor at a reactor outlet and (B) a preheater, having an inlet and an outlet. In some embodiments, the ethylene-based polymer is an ethylene homopolymer or an ethylene copolymer. In some embodiments, the monomers are brought to the polymerization pressure by one or more compressors in a sequence of compression stages. In some embodiments, the compressed monomers are passed through a pre-heater or a pre-cooler. In some embodiments, the compressed monomers are transferred into the polymerization reactor at the reactor inlet. In some embodiments, a reaction mixture obtained by the polymerization leaves the reactor at the reactor outlet through a pressure control valve. In some embodiments, a reaction mixture is cooled by a post reactor cooler. Subsequently, the reaction mixture is separated into polymeric and gaseous components in two or more stages, where (1) the gaseous components, separated off in a first stage at an absolute pressure of from 15 MPa to 50 MPa, are recycled to the one or more compressors via a high-pressure gas recycle line and (2) the gaseous components, separated off in a second stage at an absolute pressure in the range of from 0.1 MPa to 0.5 MPa, are recycled to the first stage of the sequence of compression stages via a low-pressure gas recycle line, In some embodiments, the polymeric components obtained by the polymerization are transformed into pellets.

In some embodiments, the polymerization is a homopolymerization of ethylene or a copolymerization of ethylene with one or more other monomers, provided that these monomers are free-radically copolymerizable with ethylene under high pressure. In some embodiments, the copolymerizable monomers are selected from the group consisting of α,β-unsaturated C₃-C₈-carboxylic acids, derivatives of α,β-unsaturated C₃-C₈-carboxylic acids, 1-olefins, and vinyl carboxylates. In some embodiments, the derivatives of α,β-unsaturated C₃-C₈-carboxylic acids are unsaturated C₃-C₁₅-carboxylic esters or anhydrides. In some embodiments, the vinyl carboxylates are vinyl acetate. In some embodiments, the comonomers are selected from the group consisting of propene, 1-butene, 1-hexene, acrylic acid, n-butyl acrylate, tert-butyl acrylate, 2-ethylhexyl acrylate, vinyl acetate, and vinyl propionate.

In some embodiments, the polymerization is a copolymerization, wherein the proportion of comonomer or comonomers in the reaction mixture is from 1 to 50% by weight, alternatively from 3 to 40% by weight, based on the amount of monomers, that is, the sum of ethylene and other monomers. In some embodiments, the comonomers are fed at more than one point to the reactor set-up. In some embodiments, the comonomers are fed to the suction side of the secondary compressor.

For the purposes of the present disclosure, polymers or polymeric materials are substances which are made up of at least ten monomer units. In some embodiments, the polymers or polymeric materials are low density polyethylenes, having an average molecular weight Mn of more than 20 000 g/mole. As used herein, the term “low density polyethylene” (LDPE) includes ethylene homopolymers and ethylene copolymers. In some embodiments, the present disclosure provides the process for preparing oligomers, waxes and polymers, having a molecular weight Mn of less than 20 000 g/mole.

In some embodiments and during the polymerization, the molecular weight of the polymers is altered by adding modifiers, which act as chain-transfer agents. In some embodiments, the modifiers are selected from the group consisting of hydrogen, aliphatic and olefinic hydrocarbons, ketones, aldehydes, and saturated aliphatic alcohols. In some embodiments, the aliphatic and olefinic hydrocarbons are selected from the group consisting of propane, butane, pentane, hexane, cyclohexane, propene, 1-butene, 1-pentene, and 1-hexene. In some embodiments, the ketones are selected from the group consisting of acetone, methyl ethyl ketone (2-butanone), methyl isobutyl ketone, methyl isoamyl ketone, diethyl ketone, and diamyl ketone. In some embodiments, the aldehydes are selected from the group consisting of formaldehyde, acetaldehyde, and propionaldehyde. In some embodiments, the saturated aliphatic alcohols are selected from the group consisting of methanol, ethanol, propanol, isopropanol, and butanol. In some embodiments, the modifiers are selected from the group consisting of saturated aliphatic aldehydes, 1-olefins, and aliphatic hydrocarbons. In some embodiments, the saturated aliphatic aldehydes are propionaldehyde. In some embodiments, the 1-olefins are selected from the group consisting of propene, 1-butene, and 1-hexene. In some embodiments, the aliphatic hydrocarbons are propane.

In some embodiments, the high pressure polymerization is carried out at pressures of from 110 MPa to 500 MPa, alternatively from 160 MPa to 350 MPa, alternatively from 200 MPa to 330 MPa, in a tubular reactor. In some embodiments, the high pressure polymerization is carried out at pressures of from 110 MPa to 300 MPa, alternatively from 120 MPa to 280 MPa, in an autoclave reactor. In some embodiments, the polymerization temperatures are in the range of from 100 °C to 350 °C, alternatively from 180 °C to 340 °C, alternatively from 200 °C to 330 °C, for polymerization in a tubular reactor. In some embodiments, the polymerization temperatures are in the range of from 110 °C to 320 °C, alternatively from 120 °C to 310 °C, for polymerization in an autoclave reactor.

In some embodiments, the polymerization is carried out with a variety of high-pressure reactors. In some embodiments, the high-pressure reactors are tubular reactors or autoclave reactors. In some embodiments, the polymerization is carried out in one or more tubular reactors, in one or more autoclave reactors, or combinations of such reactors. In some embodiments, the polymerization reactor is a tubular reactor.

In some embodiments, the high-pressure autoclave reactors are stirred reactors and have a length-to-diameter ratio in a range from 2 to 30, alternatively from 2 to 20. In some embodiments, the autoclave reactors have one or more reaction zones, alternatively from 1 to 6 reaction zones, alternatively from 1 to 4 reaction zones. In some embodiments, the number of reaction zones depends on the number of agitator baffles separating individual mixed zones within the autoclave reactor. In some embodiments, (a) the polymerization is carried out in an autoclave reactor and (b) the reaction mixture, coming from the compressors, is first passed through a pre-cooler before entering the autoclave reactor. In some embodiments, (a) the process uses a high-pressure polymerization system, having an autoclave reactor as the first reactor of a reactor cascade, (b) the first polymerization is carried out in the autoclave reactor, and (c) the reaction mixture, coming from the compressors, is first passed through a pre-cooler before entering the autoclave reactor.

In some embodiments, the tubular reactors are long, thick-walled pipes. In some embodiments, the tubular reactors have a length of from about 0.5 km to 4 km, alternatively from 1 km to 3 km, alternatively from 1.5 km to 2.5 km long. In some embodiments, the tubular reactors have a length-to-diameter ratio of greater than 1000:1, alternatively from 10000:1 to 40000:1, alternatively from 25000:1 to 35000:1.

In some embodiments, the tubular reactors have at least two reaction zones, alternatively from 2 to 6 reaction zones, alternatively from 2 to 5 reaction zones. The number of reaction zones is given by the number of feeding points for the initiator. In some embodiments, a feeding point is an injection point for a solution of azo compounds or organic peroxides. Fresh initiator is added to the reactor, where the initiator decomposes into free radicals and initiates further polymerization. In some embodiments, the generated heat of the reaction raises the temperature of the reaction mixture because more heat is generated than is removed through the walls of the tubular reactor. In some embodiments, the rising temperature increases the rate of decomposition of the free-radical initiators and accelerates polymerization until the free-radical initiator is consumed. Thereafter, no further heat is generated. It is believed that the temperature decreases because the temperature of the reactor walls is lower than that of the reaction mixture. Accordingly, the part of the tubular reactor downstream of an initiator feeding point, in which the temperature rises, is the reaction zone. The part, in which the temperature decreases again, is a cooling zone. In some embodiments, the amount and nature of added free-radical initiators determine how much the temperature rises, thereby permitting control of that value. In some embodiments, the temperature rise is set in the range of from 70 °C to 170 °C for the first reaction zone and 50 °C to 130 °C for subsequent reaction zones, depending on the product specifications and the reactor configuration. In some embodiments, the tubular reactor is equipped with cooling jackets for removing the heat of the reaction. In some embodiments, the reaction zones of the tubular reactor are cooled by cooling jackets.

In some embodiments, the compression of the reaction gas composition to the polymerization pressure is carried out by one or more compressors in a sequence of compression stages. In some embodiments, a primary compressor first compresses the reaction gas composition to a pressure of from 10 MPa to 50 MPa and a secondary compressor further compresses the reaction gas composition to the polymerization pressure of from 110 MPa to 500 MPa. In some embodiments, the primary compressor and the secondary compressor are multistage compressors. In some embodiments, one or more stages of one or both compressors are separated and thereby divided the stages into separated compressors. In some embodiments, a series of a single primary compressor and a single secondary compressor is used for compressing the reaction gas composition to the polymerization pressure. In some embodiments, the whole primary compressor is designated as primary compressor. In some embodiments, the one or more first stages of the primary compressor, which compress the recycle gas from the low-pressure product separator to the pressure of the fresh ethylene feed, are designated the booster compressor. In some embodiments, the one or more subsequent stages are designated the primary compressor, although the booster compressor and the subsequent stages are part of a single apparatus.

In some embodiments, the facility includes a pre-heater upstream of a tubular reactor, for heating the reaction gas composition to a temperature capable of initiating the polymerization. In some embodiments, the reaction gas composition provided by the secondary compressor is fed via a pre-heater to the inlet of the tubular reactor. In some embodiments, a part of the reaction gas composition, compressed by the secondary compressor, is fed via the pre-heater to the inlet of the tubular reactor and the remainder of the reaction gas composition, compressed by the secondary compressor, is fed as one or more side streams to the tubular reactor downstream of the inlet of the tubular reactor. In some embodiments, from 30 to 90% by weight, alternatively from 40 to 70% by weight, of the reaction gas composition is fed to the inlet of the tubular reactor and from 10 to 70% by weight, alternatively from 30 to 60% by weight, of the reaction gas composition is fed as one or more side streams to the tubular reactor downstream of the inlet of the tubular reactor.

In some embodiments, the facility includes the polymerization reactor, the reactor blow down system, and two or more gas recycle lines for recycling unreacted monomers into the polymerization process. In some embodiments, the reaction mixture, obtained in the polymerization reactor, is transferred to a first separation vessel and separated into a gaseous fraction and a liquid fraction at an absolute pressure of from 15 MPa to 50 MPa. In some instances, the first separating vessel is referred to as a high-pressure product separator. In some embodiments, the gaseous fraction is fed via a high-pressure gas recycle line to the suction side of the secondary compressor. In some embodiments and in the high-pressure gas recycle line, the gas is purified by several purification steps. In some embodiments, the removed components are entrained polymer or oligomers. In some embodiments, the liquid fraction is made from or containing dissolved monomers. In some embodiments, the dissolved monomers are ethylene and comonomers. In some embodiments, the dissolved monomers are present in an amount of 20 to 40% of weight. In some embodiments, the liquid fraction is transferred to a second separation vessel and further separated, at reduced pressure in polymeric and gaseous components. In some instances, the second separation vessel is referred to as a low-pressure product separator. In some embodiments, the reduced pressure is at an absolute pressure in the range of from 0.1 MPa to 0.5 MPa. In some embodiments, the gaseous fraction withdrawn from the second separation vessel is fed via a low-pressure gas recycle line to the primary compressor. In some embodiments, the gaseous fraction withdrawn from the second separation vessel is fed to the foremost of the stages of the primary compressor. In some embodiments, the low-pressure gas recycle line includes several purification steps for purifying the gas. In some embodiments, the facility includes additional separation steps for separating additional gaseous fractions from the reaction mixtures. In some embodiments, the facility includes additional gas recycle lines for feeding such additional gaseous fractions made from or containing not reacted monomers to one of the compressors. In some embodiments, the additional gaseous fractions are fed in-between the first separation step and the second separation step operating at an intermediate pressure.

In some embodiments, the recycled gas coming from the low-pressure gas recycle line is compressed by the first stages of the primary compressor to the pressure of the fresh feed of ethylenically unsaturated monomers and thereafter combined with the fresh gas feed. In some embodiments, the ethylenically unsaturated monomers are ethylene. In some embodiments, the combined gases are further compressed in the primary compressor to the pressure of from 10 MPa to 50 MPa. In some embodiments, the primary compressor includes five or six compression stages, wherein two or three are before adding the fresh gas and two or three are after adding the fresh gas. In some embodiments, the secondary compressor has two stages, wherein the first stage compresses the gas to a pressure in the range from 50 MPa to 150 MPa and the second stage further compresses the gas to the final polymerization pressure.

In some embodiments, the pressure within the polymerization reactor is controlled by a pressure control valve, which is arranged at the outlet of the polymerization reactor and through which the reaction mixture leaves the reactor. In some embodiments, the pressure control valve is adapted to reducing the pressure of the reaction mixture leaving the reactor to the pressure within the first separation vessel.

In some embodiments, the polymerization reactors are in a chamber having a surrounding protective wall.

In some embodiments, the polymeric components obtained by the polymerization are transformed into pellets. In some embodiments, the pelletizing apparatuses are extruders or granulators. In some embodiments, the ethylene-based polymer produced by the process is a LDPE, having a density in the range from 0.910 g/cm³ to 0.936 g/cm³.

In some embodiments, the tubular reactor is composed of individual segments. In some embodiments, the segments or tubings are flanged together. In some embodiments, the tubings are straight tubes. In some embodiments, the tubings are bends. In some embodiments, the straight tubes have a length of from 15 m to 20 m. In some embodiments, the tubes are flanged to other tubes. In some embodiments, the tubes are flanged to a bend. In some embodiments, the bends are 180° bend bends, that is, bends which are shaped in a semicircle. In some embodiments, the bends are formed such that more than one bend are flanged together. In some embodiments, two bends are flanged together to form a semicircle. In some embodiments, the bends have a small radius. In some embodiments, the centerline radius of the bends is not more than the tenfold of the average inside diameter of the bends, alternatively not more than the eightfold of the average inside diameter of the bends, alternatively not more than the fivefold of the average inside diameter of the bends.

In some embodiments, the flanges are arranged such that groups of flanges are aligned on top of each other. In some embodiments, a group of flanges is arranged one atop of the other and has at least two flanges, alternatively from 3 to 100 flanges, alternatively from 5 to 60 flanges.

In some embodiments, the cooling jackets are arranged on straight tubes. In some embodiment, each of the straight tubes is equipped with a cooling jacket. In some embodiments, water is used as a cooling medium. In some embodiments, not each of the straight tubes is supplied individually with the cooling medium. In some embodiments, adjacent straight tubes form a group. In some embodiments, the group includes two, alternatively three, alternatively four, alternatively five, alternatively six, straight tubes. In some embodiments, the group of straight tubes is supplied with the cooling medium. In some embodiments, the cooling medium is conveyed to the cooling jacket of one of the straight tubes of the group and thereafter passed through the cooling jackets of the other members of the group of straight tubes leaving the tubular reactor.

In some embodiments, the facility includes a preheater upstream of the tubular reactor. In some embodiments, the preheater is for heating the reaction fluid to a temperature capable of initiating the polymerization. In some embodiments, the preheater has an inlet into which the reaction fluid is introduced for heating and an outlet through which the heated reaction fluid leaves the preheater. In some embodiments, the preheater is a long, thick-walled pipe, having an inner diameter from 30 mm to 140 mm, alternatively from 60 mm to 120 mm. In some embodiments, the preheater is composed of individual segments. In some embodiments, the segments or tubings are flanged together. In some embodiments, the preheating tubings are straight tubes. In some embodiments, the tubings are bends. In some embodiments, the straight tubes have a length of from 15 m to 20 m. In some embodiments, the tubes are flanged to other tubes. In some embodiments, the tubes are flanged to a bend. In some embodiments, the bends are 180° bend bends, that is, bends which are shaped in a semicircle. In some embodiments, the bends are formed such that more than one bend are flanged together. In some embodiments, two bends are flanged together to form a semicircle. In some embodiments, the bends have a small radius. In some embodiments, the centerline radius of the bends is not more than the tenfold of the average inside diameter of the bends, alternatively not more than the eightfold of the average inside diameter of the bends, alternatively not more than the fivefold of the average inside diameter of the bends. In some embodiments, the flanges are arranged such that groups of flanges are aligned on top of each other. In some embodiments, a group of flanges is arranged one atop of the other and has at least two flanges, alternatively from 3 to 50 flanges, alternatively from 5 to 30 flanges.

In some embodiments, the reaction fluid, provided by the secondary compressor, is fed via the preheater to the inlet of the tubular reactor. In some embodiments, a part of the reaction fluid, compressed by the secondary compressor, is fed via the preheater to the inlet of the tubular reactor and the remainder of the reaction fluid, compressed by the secondary compressor, is fed as one or more side streams to the tubular reactor downstream of the inlet of the tubular reactor. In some embodiments, from 30 to 90% by weight, alternatively from 40 to 70% by weight, of the reaction fluid is fed to the inlet of the tubular reactor and from 10 to 70% by weight, alternatively from 30 to 60% by weight, of the reaction fluid is fed as one or more side streams to the tubular reactor downstream of the inlet of the tubular reactor.

In some embodiments, the facility includes the polymerization reactor and two or more gas recycle lines for recycling unreacted monomers into the polymerization process. In some embodiments, the reaction mixture, obtained in the polymerization reactor, is transferred to a first separation vessel and separated into a gaseous fraction and a liquid fraction at an absolute pressure of from 15 MPa to 50 MPa. In some instances, the first separating vessel is referred to as a high-pressure product separator. In some embodiments, the gaseous fraction is fed via a high-pressure gas recycle line to the suction side of the secondary compressor. In some embodiments and in the high-pressure gas recycle line, the gas is purified by several purification steps. In some embodiments, the removed components are entrained polymer or oligomers. In some embodiments, the liquid fraction is made from ore containing dissolved monomers. In some embodiments, the dissolved monomers are ethylene and comonomers. In some embodiments, the dissolved monomers are present in an amount of 20 to 40% of weight. In some embodiments, the liquid fraction is transferred to a second separation vessel and further separated, at reduced pressure, in polymeric and gaseous components. In some instances, the second separation vessel is referred to as a low-pressure product separator. In some embodiments, the reduced pressure is at an absolute pressure in the range of from 0.1 MPa to 0.5 MPa. In some embodiments, the gaseous fraction withdrawn from the second separation vessel is fed via a low-pressure gas recycle line to the primary compressor. In some embodiments, the gaseous fraction withdrawn from the second separation vessel is fed to the foremost of the stages of the primary compressor. In some embodiments, the low-pressure gas recycle line includes several purification steps for purifying the gas. In some embodiments, the facility includes additional separation steps for separating additional gaseous fractions from the reaction mixtures. In some embodiments, the facility includes additional gas recycle lines for feeding such additional gaseous fractions made from or containing not reacted monomers to one of the compressors. In some embodiments, the additional gaseous fractions are fed in-between the first separation step and the second separation step operating at an intermediate pressure.

In some embodiments, the facility includes a post reactor cooler downstream of the polymerization reactor. In some embodiments, the post reactor cooler is for cooling the reaction mixture. In some embodiments, the post reactor cooler is arranged upstream of the pressure control valve. In some embodiments, the post reactor cooler is arranged downstream of the pressure control valve. In some embodiments, the post reactor cooler is a long, thick-walled pipe, having an inner diameter from 30 mm to 120 mm, alternatively from 60 mm to 100 mm. In some embodiments, the post reactor cooler is composed of individual segments. In some embodiments, the segments or cooling tubings are flanged together. In some embodiments, the cooling tubings are straight tubes. In some embodiments, the tubings are bends. In some embodiments, the straight tubes have a length of from 15 m to 20 m. In some embodiments, the tubes are flanged to other tubes. In some embodiments, the tubes are flanged to a bend. In some embodiments, the bends are 180° bends, that is, bends which are shaped in a semicircle. In some embodiments, the bends are formed such that more than one bend are flanged together. In some embodiments, two bends are flanged together to form a semicircle. In some embodiments, the bends have a small radius. In some embodiments, the centerline radius of the bends is not more than the tenfold of the average inside diameter of the bends, alternatively not more than the eightfold of the average inside diameter of the bends, alternatively not more than the fivefold of the average inside diameter of the bends. In some embodiments, the flanges are arranged such that groups of flanges are aligned on top of each other. In some embodiments, a group of flanges is arranged one atop of the other and has at least two flanges, alternatively from 3 to 80 flanges, alternatively from 5 to 60 flanges.

In some embodiments, the process is a radical polymerization carried out in the presence of free-radical polymerization initiators. In some embodiments, initiators for starting the free-radical polymerization in the respective reaction zones are substances capable of producing radical species under the conditions in the polymerization reactor. In some embodiments, the initiators are selected from the group consisting of oxygen, air, azo compounds, and peroxidic polymerization initiators. In some embodiments, the polymerizations are carried out by using oxygen, fed in the form of pure O₂ or as air. In some embodiments and with oxygen as an initiator, the initiator is first mixed with the ethylene feed and then fed to the reactor. In some embodiments, a stream made from or containing monomer and oxygen is fed (a) to the beginning of the polymerization reactor and (b) to one or more points along the reactor, creating two or more reaction zones. In some embodiments, the initiator is selected from the group consisting of organic peroxides and azo compounds. In some embodiments, the organic peroxides are selected from the group consisting of peroxy esters, peroxy ketals, peroxy ketones and peroxycarbonates. In some embodiments, the peroxycarbonates are selected from the group consisting of di(2-ethylhexyl) peroxydicarbonate, dicyclohexyl peroxydicarbonate, diacetyl peroxydicarbonate, tert-butyl peroxyisopropylcarbonate, and di-sec-butyl peroxydicarbonate. In some embodiments, the organic peroxides are selected from the group consisting of di-tert-butyl peroxide, di-tert-amyl peroxide, dicumyl peroxide, 2,5-dimethyl-2,5-di-tert-butylperoxyhexane, tert-butyl cumyl peroxide, 2,5-dimethyl-2,5-di(tert-butylperoxy) hex-3-yne, 1,3-diisopropyl monohydroperoxide, tert-butyl hydroperoxide, didecanoyl peroxide, 2,5-dimethyl-2,5-di(2-ethylhexanoylperoxy) hexane, tert-amyl peroxy-2-ethylhexanoate, dibenzoyl peroxide, tert-butyl peroxy-2-ethylhexanoate, tert-butyl peroxydiethylacetate, tert-butyl peroxydiethylisobutyrate, tert-butyl peroxy-3,5,5-trimethylhexanoate, 1,1-di(tert-butylperoxy)-3,3,5-trimethylcyclohexane, 1,1-di(tert-butylperoxy)cyclohexane, tert-butyl peroxyacetate, cumyl peroxyneodecanoate, tert-amyl peroxyneodecanoate, tert-amyl peroxypivalate, tert-butyl peroxyneodecanoate, tert-butyl permaleate, tert-butyl peroxypivalate, tert-butyl peroxyisononanoate, diisopropylbenzene hydroperoxide, cumene hydroperoxide, tert-butyl peroxybenzoate, methyl isobutyl ketone hydroperoxide, 3,6,9-triethyl-3,6,9-trimethyl-triperoxocyclononane and 2,2-di(tert-butylperoxy) butane. In some embodiments, the azo compounds are selected from the group consisting of azoalkanes (diazenes), azodicarboxylic esters, and azodicarboxylic dinitriles. In some embodiments, the azodicarboxylic dinitriles are azobisisobutyronitrile. In some embodiments, the initiators are hydrocarbons, which decompose into free radicals, and are herein referred to as C—C initiators. In some embodiments, the hydrocarbons are selected from the group consisting of 1,2-diphenyl-1,2-dimethylethane derivatives and 1,1,2,2-tetramethylethane derivatives. In some embodiments, the process uses individual initiators or mixtures of various initiators. In some embodiments, the initiators are commercially available. In some embodiments, the commercially available initiators are peroxides. In some embodiments, the commercially available initiators are from Akzo Nobel under the trade names Trigonox® or Perkadox®.

In some embodiments, peroxidic polymerization initiators are selected from the group consisting of 1,1-di(tert-butylperoxy)cyclohexane, 2,2-di(tert-butylperoxy) butane, tert-butyl peroxy-3,5,5-trimethylhexanoate, tert-butyl peroxybenzoate, 2,5-dimethyl-2,5-di(tert-butylperoxy) hexane, tert-butyl cumyl peroxide, di-tert-butyl peroxide and 2,5-dimethyl-2,5-di(tert-butylperoxy) hex-3-yne. In some embodiments, peroxidic polymerization initiators are selected from the group consisting of tert-butyl peroxy-3,5,5-trimethylhexanoate, di-(2-ethylhexyl) peroxydicarbonate, and tert-butyl peroxy-2-ethylhexanoate.

In some embodiments, the initiators are used individually or as a mixture. In some embodiments, the initiators are used in concentrations of from 0.1 mol/t to 50 mol/t of polyethylene produced, alternatively from 0.2 mol/t to 20 mol/t, in each reaction zone. In some embodiments, the free-radical polymerization initiator, which is fed to a reaction zone, is a mixture of at least two different azo compounds or organic peroxides. In some embodiments, the mixtures are fed to the reaction zones. In some embodiments, the number of different initiators in a mixture varies. In some embodiments, the mixtures are composed of from two to six, alternatively two, alternatively three, alternatively four, different initiators. In some embodiments, the mixtures are made from or containing initiators having different decomposition temperatures.

In some embodiments, the initiators are in the dissolved state. In some embodiments, the solvents are selected from the group consisting of ketones and aliphatic hydrocarbons. In some embodiments, the aliphatic hydrocarbons are selected from the group consisting of octane, decane, isododecane, and other saturated C₈-C₂₅-hydrocarbons. In some embodiments, the solutions are made from or containing the initiators or initiator mixtures in proportions of from 2 to 65% by weight, alternatively from 5 to 40% by weight, alternatively from 8 to 30% by weight.

In some embodiments, the polymerization is carried out in the presence of a chain transfer agent. As used herein, the term “chain transfer agents” refers to chemical compounds that may interact with a growing polymer chain, terminate the further growth of the growing polymer chain and induce the growth of another growing chain. In some embodiments, chain transfer agents alter the molecular weight of the polymers to be prepared. In some instances, chain transfers agents are alternatively referred to as modifiers or regulators. In some embodiments, the chain transfer agents are selected from the group consisting of hydrogen, aliphatic and olefinic hydrocarbons, ketones, aldehydes, saturated aliphatic alcohols, and mixtures of these compounds. In some embodiments, the aliphatic and olefinic hydrocarbons are selected from the group consisting of propane, butane, pentane, hexane, cyclohexane, propene, 1-butene, 1-pentene, and 1-hexene. In some embodiments, the ketones are selected from the group consisting of acetone, methyl ethyl ketone (2-butanone), methyl isobutyl ketone, methyl isoamyl ketone, diethyl ketone, and diamyl ketone. In some embodiments, the aldehydes are selected from the group consisting of formaldehyde, acetaldehyde, and propionaldehyde. In some embodiments, the saturated aliphatic alcohols are selected from the group consisting of methanol, ethanol, propanol, isopropanol, and butanol. In some embodiments, the chain transfer agents are selected from the group consisting of saturated aliphatic aldehydes, olefinic hydrocarbons, or aliphatic hydrocarbons, and mixtures of these compounds. In some embodiments, the saturated aliphatic aldehydes are propionaldehyde. In some embodiments, the olefinic hydrocarbons are selected from the group consisting of propene, 1-butene, and 1-hexene. In some embodiments, the aliphatic hydrocarbons are propane. In some embodiments, the amount of chain transfer agent fed to the tubular reactor is from 0.2 kg/t prepared polymer to 40 kg/t prepared polymer, alternatively 0.4 kg/t prepared polymer to 20 kg/t prepared polymer. In some embodiments, a chain transfer agent is made from or containing at least one aldehyde, at least one ketone, or both. In some embodiments, the amount of added aldehydes and ketones is from 0.4 kg/t of prepared polymer to 10 kg/t of prepared polymer.

In some embodiments, propionic aldehyde is the chain transfer agent, in the absence of other chain transfer agents. In some embodiments, the chain transfer agent is a mixture of propionic aldehyde and one or more olefinic hydrocarbons.

In some embodiments, the present disclosure provides polymers obtained by the process. In some embodiments, the present disclosure provides articles of manufacture made from or containing the polymers. In some embodiments, the articles of manufactures are selected from the group consisting of shaped articles. In some embodiments, the shaped articles are selected from the group consisting of films, laminating films or sheets, fibers, cables or wires, and molded parts. In some embodiments, methods for preparing shaped articles include extrusion molding, extrusion coating, blow molding, rotomolding, and injection molding. In some embodiments, the polymers are for producing films. In some embodiments, the films are prepared on blown film machines or cast film lines. In some embodiments, the shaped article is a film.

As used herein, the term “conversion rate” refers to polymerized monomer at the end of the reaction based on total starting monomer.

### EXAMPLES

### Density

Density was determined according to DIN EN ISO 1183-1:2004, Method A (Immersion) with compression-molded plaques of 2 mm thickness. The compression-molded plaques were prepared with a defined thermal history: Pressed at 180 °C, 20 MPa for 8 min with subsequent crystallization in boiling water for 30 min.

### Melt Flow Rate

The melt flow rate MFR was determined according to DIN EN ISO 1133:2005, condition D at a temperature of 190 °C under a load of 2.16 kg.

### Molecular Weight Distribution Determination

The determination of the molar mass distributions and the means Mn, Mw, Mz and Mw/Mn derived therefrom was carried out by high-temperature gel permeation chromatography using a method described in ISO 16014-1, -2, -4, issues of 2003. The specifics according to the mentioned ISO standards were as follows: Solvent 1,2,4-trichlorobenzene (TCB), temperature of apparatus and solutions 135 °C and, as concentration detector, a PolymerChar (Valencia, Paterna 46980, Spain) IR-4 infrared detector, for use with TCB. An Agilent PL-GPC-220 equipped with a pre-column SHODEX UT-G and separation columns SHODEX UT 806 M (3×) and SHODEX UT 807 (Showa Denko Europe GmbH, Konrad-Zuse-Platz 4, 81829 Muenchen, Germany) connected in series.

The solvent was vacuum distilled under Nitrogen and stabilized with 0.025% by weight of 2,6-di-tert-butyl-4-methylphenol. The flowrate used was 1 ml/min. The injection was 500 μl. The polymer concentration was in the range of 0.01%<conc. <0.05% w/w. The molecular weight calibration was established by using monodisperse polystyrene (PS) standards from Polymer Laboratories (now Agilent Technologies, Herrenberger Str. 130, 71034 Boeblingen, Germany) in the range from 580 g/mol up to 11600000 g/mol and additionally with hexadecane.

The calibration curve was then adapted to Polyethylene (PE) by the Universal Calibration method (Benoit H., Rempp P. and Grubisic Z., & in J. Polymer Sci., Phys. Ed., 5, 753 (1967)). The Mark-Houwing parameters used were for PS: kps=0.000121 dl/g, aps=0.706 and for PE KPE=0.000406 dl/g, aPE-0.725, valid in TCB at 135 °C. Data recording, calibration and calculation were carried out using NTGPC_Control_V6.02.03 and NTGPC_V6.4.24 (hs GmbH, Hauptstraße 36, D-55437 Ober-Hilbersheim, Germany) respectively.

Furthermore, Mw was measured by Gel Permeation Chromatography (GPC) coupled with Multi-Angle Laser-Light Scattering (MALLS), which is also referred to as GPC-LS. The radius of gyration for each fraction eluted from the GPC (as described above but with a flow-rate of 0.6 ml/min and a column packed with 30 mm particles) was measured by analyzing the light scattering at the different angles with the MALLS (detector Wyatt Dawn HELEOS II, Wyatt Technology, Santa Barbara, Calif.). A laser source of 120 mW of wavelength 658 nm was used. The specific index of refraction was taken as 0.104 ml/g. Data evaluation was done with Wyatt ASTRA 7.3.1 software. The measurement allowed for determination of a long chain branching (LCB) index. The LCB index corresponds to the branching factor g′, measured for a molecular weight of 106 g/mol. The branching factor g′ allows determining long-chain branches at high Mw. The LCB Index was determined as follows:

The parameter g′ is the ratio of the measured mean square radius of gyration to that of a linear polymer having the same molecular weight. Linear molecules show a g′ value of 1 while values less than 1 indicate the presence of LCB. Values of g′ as a function of mol. weight, M, were calculated from the equation:

$${g}^{′} ( M ) = \frac{< {Rg}^{2} {>}_{sample , M}}{< {Rg}^{2} {>}_{linear ref . , M}}$$

where <Rg²>_{, M} is the root-mean-square radius of gyration for the fraction of mol. weight M.

The radius of gyration for each fraction eluted from the GPC (as described above but with a flow-rate of 0.6 ml/min and a column packed with 30 mm particles) was measured by analyzing the light scattering at the different angles.

The mol. weight M and <Rg²>_{sample,M} were determined, and the g′ was defined at a measured M=106 g/mol. The <Rg²>_{linear ref.,M} was calculated by the relation between radius-of-gyration and molecular weight for a linear polymer in solution (Zimm and Stockmayer W H 1949)) and confirmed by measuring a linear PE reference.

The protocol was as described in the following documents:

Zimm B H, Stockmayer W H “The dimensions of chain molecules containing branches and rings.” J Chem Physics 17, and Rubinstein M., Colby R H. (2003), Polymer Physics, Oxford University Press.

### Haze

As used herein, the term “haze” refers to the percentage of transmitted light in passing through the polymer that deviates from the incident beam by forward scattering. In some instances, haze imparts a cloudy or milky appearance to the sample. Haze was determined according to ASTM D 1003-00, using 50 μm thickness blown film extruded at a melt temperature of 180 °C and a blow-up ratio of 2.5:1. In some instances, this test method covers the evaluation of specific light-transmitting and wide-angle-light-scattering properties of planar sections of materials. In some instances, the materials are transparent plastic. In some instances, light that is scattered upon passing through a film or sheet of a material produces a hazy or smoky field when objects are viewed through the material. “Haze” was determined as an average of the percentage of light that deviates from the incident beam by more than 2.5°.

### Clarity

“Clarity” is a measurement of narrow angle scattering and a standardized characterization of the translucence or “see-through” property of an optically transmissive component. Clarity was measured on BYK Haze-gard I equipment (available from BYK-Gardner GmbH), as an added measurement to the ASTM D1003 test method configuration established for the haze.

### Gloss

Gloss was determined at 60° according to ASTM D 2457-03, using 50 μm thickness blown film extruded at a melt temperature of 180 °C and a blow-up ratio of 2.5:1.

### Conversion Rate

As used herein, the conversion rate corresponded to the hourly production rate [t/h] divided by the hyper compressor throughput [t/h] times 100%.

TABLE 1
Reactor sizes used in the experiments

| | Tube diameter | Reactor | Volume | Surface | |
|---|---|---|---|---|---|
| | D, | length L, | V, | area A, | |
| | [mm] | [m] | [m³] | [m²] | V/A |
| Reactor 1 | 40 | 934 | 1.1731 | 117.3104 | 0.010 |
| Reactor 2 | 76 | 2210 | 10.0256 | 527.6710 | 0.019 |

### Example 1 (Reactor 2 with Low Conversion Rate)

A LDPE film grade was produced by continuous polymerization of ethylene as ethylenically unsaturated monomer in a high-pressure tubular reactor. The reactor had, in total, a length of 2210 m and a design pressure of 300 MPa. The tubular reactor was composed of reactor tubes having a length of 13 m with an outer diameter do of 180 mm and an inner diameter dᵢ of 76 mm. The resulting volume to surface ratio V/A was 0.0190.

Propionic aldehyde was added, as chain transfer agent, to the fresh ethylene stream entering the primary compressor in an amount of 1.4 kg per t of produced polyethylene. The secondary compressor was operated with a throughput of 117 t reaction gas composition per hour. The compressed reaction gas composition was heated to 155 °C in a pre-heater and fed to the inlet of the tubular reactor, having a pressure of 280 MPa. For removing the generated heat of polymerization, cooling water was circulated through cooling jackets attached to the outer surface of the reactor tubes. The reaction mixture discharged from the tubular reactor was passed through a post reactor cooler and separated from volatiles in two steps via a first separation vessel and a second separation vessel. The degassed liquid polymer was conveyed to an extruder and granulator to form LDPE pellets. Within a period of 24 hours of continuous production, 31.2 t/h of LDPE were obtained having the properties summarized in Table 2. Accordingly, the conversion rate of ethylene per pass through the reactor was 26.7%.

The continuous hourly production was reduced by increasing the preheater outlet temperature, lowering the peak temperature and adjusting the cooling water temperature of the reactor.

### Example 2 (Comparative, Reactor 2 with Higher Conversion Rate)

The polymerization of Example 1 was repeated. However, the conversion rate of ethylene per pass through was increased to 31.9%, obtaining within a period of 24 hours of continuous production 37.4 t/h of LDPE, having the properties summarized in Table 2.

The continuous hourly production was increased by decreasing the preheater outlet temperature, increasing the peak temperature and adjusting the cooling water temperature of the reactor.

### Example 3 (Comparative, Reactor 1 with the Low Conversion Rate of Example 1)

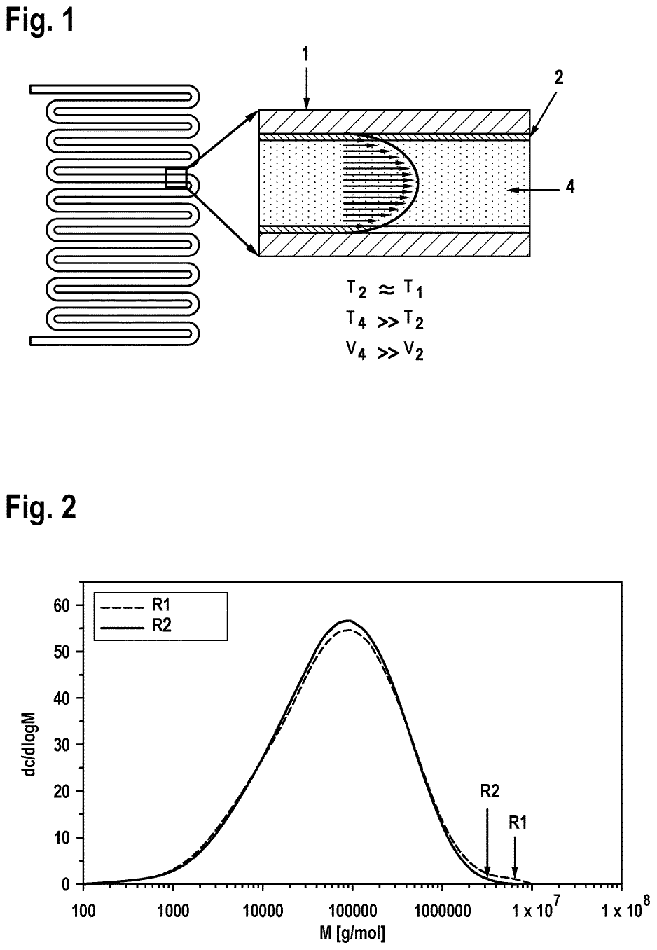

A film grade of LDPE of the same density and melt flow rate as the film grade LDPE prepared in Example 1 was produced by continuous polymerization of ethylene as ethylenically unsaturated monomer in a high-pressure tubular reactor of the design shown in FIG. 1, having, in total, a length of 934 m and a design pressure of 300 MPa. The tubular reactor was composed of reactor tubes having a length of 10 m, an outer diameter do of 96 mm and an inner diameter of di of 40 mm, thereby resulting in a volume to surface ratio V/A of 0.0100.

Propionic aldehyde was added, as chain transfer agent, to the fresh ethylene stream entering the primary compressor in an amount of 1.4 kg per t of produced polyethylene. The secondary compressor was operated with a throughput of 30 t reaction gas composition per hour.

The polymerization was carried out as described in Example 1. Within a period of 24 hours of continuous production, 8 t of LDPE were obtained having the properties summarized in Table 2. Accordingly, the conversion rate of ethylene per pass through the reactor was 26.7%, the same as in Example 1.

TABLE 2
Results from Experiments 1 to 3

| | | Example 2^{b} | Example 3^{c} |
|---|---|---|---|
| | Example 1^{a} | (comparative) | (comparative) |
| Density [g/cm³] | 0.9245 | 0.9241 | 0.9237 |
| MFR_{2.16} [g/10 min] | 0.68 | 0.66 | 0.65 |
| Haze [%] | 6.1 | 7.4 | 6.7 |
| Gloss 20° | 74 | 37 | 47 |
| Gloss 60° | 113 | 90 | 98 |
| Clarity [%] | 98.3 | 95.0 | 96.0 |
| DDI [g] | 138 | 196 | 194 |
| Mn | 21602 | 19622 | 17068 |
| Mw | 84504/108783 | 106067/141715 | 94485/175230 |
| (GPC/GPC_LS) | | | |

^{a}average value from 6 runs.
^{b}average value from 13 runs.
^{a}average value from 7 runs.

It is believed that the flow in a tubular LDPE reactor is as follows with reference to FIG. 1. A tube 1, having an edge layer 2, is located adjacent to the inner walls of the reactor. The tube 1 further has a core layer 4, which is indicated with the dotted hashing. The temperature of the edge layer T₂ is about the same as the temperature of the tube wall T₁, wherein the temperature of the core layer T₄ is much higher than the temperature of the edge layer T₂. The velocity in the core layer v₄ is higher than the velocity in the edge layer v₂. In the edge layer 2, a high molecular weight fraction was produced, which impacted the MWD of the final product. In smaller tubular reactors, the impact of this edge layer 2 to the MWD is much more pronounced, in comparison to larger reactors. The data in Table 2 shows this effect. FIG. 2 indicates the MWD of the LDPE produced in different tubular reactors. With increasing size of the tubular reactors in combination with higher conversion rates, the MWD is narrowed due to the reduced amount of the high molecular weight fraction.

When comparing the optical properties of the product of example 1 and comparative examples 2 and 3 and when operating reactor 2 at the same conversion rate as reactor 1, the reactor 2 (R2) product showed better optical properties in comparison to product as produced in reactor 1 (R1) (for example, in terms of haze).

1. A process for the preparation of ethylene homopolymers or copolymers, in a facility;
comprising
(A) a high-pressure tubular reactor, used in a continuous flow mode, with
(i) a reaction fluid comprising ethylene introduced into the reactor at a reactor inlet and
(ii) polymer leaving the reactor at a reactor outlet, and
(B) a preheater, having an inlet and an outlet,
comprising the steps of:
a) compressing the reaction fluid to an elevated pressure;
b) heating at least a portion of the reaction fluid in the preheater, thereby yielding heated reaction fluid;
c) introducing the reaction fluid heated in step b) into the reactor at the reactor inlet; and
d) polymerizing the reaction fluid at temperatures from 100 °C to 350 °C and pressures in the range from 180 MPa to 340 MPa, in the presence of free-radical polymerization initiators in the reactor,
wherein
the tubular reactor has a volume V [in m³] and an inner surface area A [in m²],
the ratio V/A is higher than 0.016, and
the reactor is run at a monomer conversion in a range of from 22 to 31%.

2. The process of claim 1, wherein the reactor has a volume to inner surface area ratio in a range of from 0.019 to 0.022.

3. The process of claim 1, wherein the conversion rate is in a range of from 23 to 29.

4. The process according to claim 1, wherein the tubular reactor has an inner diameter dᵢ of from 65 to 120 mm.

5. The process according to claim 1, wherein the tubular reactor is composed of tubes of a length of from 5 m to 25 m.

6. The process according to claim 1, wherein the design pressure p_{des} of the tubular reactor is from 240 MPa to 400 MPa.

7. The process according to claim 1, wherein the feed rate of the reaction gas composition to the tubular reactor is from 80 t/h to 210 t/h.

8. The process of claim 1, wherein step b) further comprises adding one or more chain-transfer agents.

9. The process of claim 8, wherein the chain transfer agent is selected from the group consisting of aldehydes and ketones and the amount of added aldehydes and ketones is in a range of from 0.4 kg/t of prepared polymer to 10 kg/t of prepared polymer.

10. The process according to claim 8, wherein the chain transfer agent is (a) propionic aldehyde, in the absence of other chain transfer agents or (b) a mixture of propionic aldehyde and one or more olefinic hydrocarbons.

11. The process of claim 1, wherein the average velocity of the reaction fluid at the outlet of the preheater is lower than the average velocity of the reaction fluid in the tubular reactor at the reactor inlet and the ratio of the average velocity of the reaction fluid in the tubular reactor at the reactor inlet to the average velocity of the reaction fluid in the preheater at the outlet of the preheater is in the range from 1.5 to 5.

12. The process of claim 1, wherein, in step a), the pressure of the reaction fluid after compression ranges from 180 MPa to 320 MPa, in step c), when introducing the heated reaction fluid into the reactor, the pressure of the reaction fluid ranges from 175 MPa to 315 MPa, or both.

13. The process of claim 1, wherein, in step c), when introducing the heated reaction fluid into the reactor, the temperature of the reaction fluid ranges from 130 °C to 180 °C.

14. A low density polyethylene, prepared by the process of claim 1, having
a) a density in a range of from 0.910 to 0.936 g/, determined according to ISO 1183-1 at 23 °C;
b) an Mw value in a range of from 70.000 to 100.000, where Mw is the weight average molecular weight, measured by GPC;
c) an Mn value in a range of from 18.000 to 24.000, where Mn is the number average molar mass, measured by GPC;
d) a gloss 20° value [as measured according to ASTM D 2457] of 74 or more;
e) a gloss 60° value [as measured according to ASTM D 2457] of 114 or more;
f) a haze value [as measured according to ASTM D 1003] of less than 6;
g) a melt flow rate in a range of from 0.67 to 1.0 g/10, determined according to ISO 1133-1;
h) a dart drop impact strength, F50, in a range of from 130 to 200 g, determined according to ASTM D1709; or
i) a clarity in a range of from 97.0 to 99.3.

15. A low density polyethylene according to claim 14, having the characteristics (a)-(i).
